(19) United States
(12) Patent Application Publication
(10) Pub. No.: US 2012/0288230 A1
(43) Pub. Date: Nov. 15, 2012

(54) Non-Reflective Optical Connections in Laser-Based Photoplethysmography

(75) Inventors: Jonas Alexander Pologe, Boulder, CO (US); Theodore Philip Delianides, Boulder, CO (US)

(73) Assignee: KESTREL LABS, INC., Boulder, CO (US)

(21) Appl. No.: 13/107,132

(22) Filed: May 13, 2011

(51) Int. Cl. G02B 6/26

(52) U.S. Cl. 385/31

(57) ABSTRACT

An embodiment of a light delivery portion of a photoplethysmographic device having a series of two or more optical elements. The series of two or more optical elements (20, 40, 50) are arranged to conduct light (10) from a laser and at least two consecutive elements of the series of two or more optical elements are coupled together by a non-reflective coupling (30a, 30b). This minimizes the extent to which back reflected light can re-enter the laser and adversely alter the optical output properties of the laser and additionally minimizes the light loss associated with back reflection thus helping to maximize the optical throughput. Other embodiments are described and shown.

### STATEMENT REGARDING FEDERALLY SPONSORED RESEARCH OR DEVELOPMENT

This invention was made with government support under R44 HL073518 awarded by the National Institutes of Health. The government has certain rights in the invention.

### BACKGROUND-PRIOR ART

| U.S. patents | | | |
|---|---|---|---|
| Pat. No. | Kind Code | Issue Date | Patentee |
| 4,880,304 | | Nov. 14, 1989 | Jaeb |

| Application | | | |
|---|---|---|---|
| Number | Kind Code | Publication Date | Applicant |
| US 2004/0153008 | A1 | Aug. 5, 2004 | Sharf |
| US 2005/0187439 | A1 | Aug. 25, 2005 | Blank |

### BACKGROUND OF THE INVENTION

In the science of photoplethysmography, light is used to illuminate or transilluminate living tissue for the purpose of providing noninvasive measurements of blood analytes or other hemodynamic parameters or tissue properties. In this monitoring modality light is directed into living tissue and a portion of the light which is not absorbed by the tissues, or scattered in some other direction, is detected a short distance from the point at which the light entered the tissue. The detected light is converted into electronic signals that are indicative of the received light intensity exiting the tissue. These signals, one for each emitter, or spectral band of light incident on the living tissue (referred to in this specification as the tissue-under-test), vary with the pulsation of the blood through the tissue-under-test. These time varying signals are referred to as photoplethysmographic signals. The photoplethysmographic signals are used to calculate blood analytes such as arterial blood oxygen saturation and/or hemodynamic, variables such as heart rate, cardiac output, or tissue perfusion. Among the blood analytes that may be measured by photoplethysmography are various types of hemoglobin, including the percentages of oxyhemoglobin, carboxyhemoglobin, methemoglobin, and reduced hemoglobin in the arterial blood. A device which detects and processes photoplethysmographic signals to measure the levels of various blood analytes and/or various hemodynamic parameters is referred to as a photoplethysmographic measurement apparatus, photoplethysmographic device, or photoplethysmographic instrument.

The first widespread commercially-used photoplethysmographic device in medicine was the pulse oximeter, a photoplethysmographic device designed to measure arterial blood oxygen saturation. To measure oxygen saturation two different bands of light must be used, with each light band possessing a unique spectral content. Each spectral band, or light band, is typically referred to by a center wavelength, the centroid (or first moment of area of the wavelength distribution of the spectral band), or sometimes by a peak wavelength (the wavelength of maximum optical power). In conventional pulse oximetry two different emitters such as light emitting diodes (LEDs) are commonly used to generate the desired spectral bands. Usually one LED has a center, or peak, wavelength near 660 nanometers (nm) and a second LED has a center, or peak, wavelength near 900 nm. More recently photoplethysmographic instruments have been developed in which more, than two light bands are utilized to allow the measurement of a larger number of blood analytes, including such blood analytes as oxyhemoglobin, carboxyhemoglobin, methemoglobin, and reduced hemoglobin.

Use of a photoplethysmographic instrument requires that light from each emitter (each light band) is incident on the tissue-under-test. On a person the tissue-under-test usually consists of a finger, earlobe, toe, foot, cheek, forehead, or other site on or, for invasive use, inside the body. The emitter light is delivered via a sensor positioned on the tissue-under-test. The tissue-under-test is preferably well perfused with blood which helps provide a strong photoplethysmographic (or pulsatile) optical signal to be received at the detector that is typically also integral to the sensor. The detector is located a short distance from where the light enters the tissue-under-test, which allows for attenuation of the light signal by the pulsating blood flow within the tissue-under-test.

As the science of photoplethysmographic monitoring has progressed, an increasing number of light bands have been required to measure an increasing number of blood analytes. Furthermore, to improve the accuracy of measurement and the ability to discriminate between an ever-increasing number of blood analytes, it is most desirable to use spectrally-stable narrowband light sources. One type of spectrally-stable narrowband light source is a laser.

The use of one or more lasers in photoplethysmography creates some unique challenges. These include the requirement that the laser be located at a distance from the sensor and that certain instabilities are caused by light emitted by the laser being reflected back toward the laser.

When using one or more lasers as light sources, or emitters, in a photoplethysmographic device, the lasers often cannot be placed in the sensor that is positioned in close proximity to, or directly on, the tissue-under-test, as has been typical with LED based photoplethysmographic sensors. This might be due to the physical size of the laser device being too large for placement in a small sensor designed for application to commonly-used sensing sites such as a finger. It also might be due to the need to position the laser in close proximity to its driver electronics, to one or more heat sinks, or to other electro-mechanical devices that, as a whole, create a package that is too large or cumbersome to place in the sensor or to conveniently position in immediate proximity to the tissue-under-test.

A typical photoplethysmographic instrument consists of a monitor, which provides the user interface for the instrument; a cable, which connects the monitor to a sensor; and the sensor, which is placed on the tissue-under-test. Many different but substantially equivalent configurations of the instrument are also possible. The lasers, given that they are not housed in the sensor, might be housed in the monitor or at some intermittent point along the cable connecting the monitor to the sensor. Regardless of exactly where the lasers are housed, as long as they are not at the sensor, the light emitted by the laser (or lasers) must be transmitted from the laser housing to the sensor, or at least to the sensing location on the tissue-under-test.

In such cases, this light transmission from the laser to the sensor is typically accomplished by employing a light guide. The light guide may be any one of a number of elements, or a chain of elements, including optical elements such as glass or plastic optical fibers, liquid filled light guides, fiber optic bundles, or other light pipes.

Light guides have been used in photoplethysmographic devices since the late 1970s when the first commercially available pulse oximeter went on the market. One early photoplethysmographic instrument used a pair of light guides in the form of two fiber bundles to both deliver the light, from a tungsten lamp source, to the tissue-under-test and to receive the light from the tissue-under-test and return the photoplethysmographic signals to the monitor for analysis. More recently, light guides have been used in pulse oximeters specifically designed for use on patients undergoing MRI (Magnetic Resonance Imaging) examination. None of these light guide-based devices, however, addressed the problems associated with the instabilities caused by a portion of the light incident on the light guide reflecting back toward the emitter, and in specific, a laser-based emitter.

Coupling, or launching, light emitted by a laser into a light guide for use in a photoplethysmographic measurement device can cause a portion of the light emitted by the laser to reflect back into the laser cavity. This back reflection occurs due to the discontinuity in index of refraction that the light encounters after exiting the laser into the air and then entering the light guide. These effects are well-known in the field of optics and described by the equations for Fresnel reflections. As an example, if light is passing from air into a light guide, such as a glass optical fiber, then the light is passing from an index of refraction of approximately 1.0 to an index of refraction that might be near 1.5. If the light is entering the light guide at an angle that is perpendicular to the surface of this particular light guide, the back reflection of the light from the surface of the light guide would be approximately 4% of the incident light intensity.

Back reflections of this magnitude can cause several adverse effects, any one of which can be detrimental to the accuracy of a photoplethysmographic measurement technology that is using laser light sources. These detrimental effects occur because the light reflected off the surface of the light guide can re-enter the laser cavity and interfere with the performance of the laser.

Depending on the exact type of laser used, light emitted by the laser and reflected off the front surface of the light guide back toward the laser cavity can cause problems such as reducing the mode hop spacing as a function of temperature, inducing additional mode hops because of secondary and tertiary resonant cavities formed between the laser facets and the light guide end face, and increasing the magnitude of the wavelength shift associated with any individual mode hop. (In this specification the term mode refers to resonant modes, also called longitudinal modes, of the laser cavity; and mode hopping refers to sudden jumps in the optical frequency, or spectral content, of the light output by the laser. Changes in output intensity occur concurrently with, and because of, the mode hops. See the following article: Romanian Reports in Physics, Vol. 59, No. 1, P. 87-92, 2007, included herein by reference, for additional understanding of the modal behavior in diode laser use.)

For photoplethysmographic measurement of blood analytes to be accurate, the light incident on the tissue-under-test must be stable in amplitude and in spectral content (or at least very controlled in amplitude and spectral content and devoid of unintended fluctuations in intensity or wavelength to the greatest extent possible). In laser-based photoplethysmographic instrument systems, the back reflection of light towards a source laser when launching its light into a light guide causes fluctuations in intensity and spectral content (or wavelength) that are large enough to dramatically reduce the accuracy of the photoplethysmographic measurements.

It should be noted that these fluctuations in intensity and spectral content can be small enough that they do not adversely affect other non-photoplethysmographic uses of lasers coupled to light guides. But in the case of photoplethysmography, changes in output intensity as small as 0.5% can obscure the signals that are required for accurate blood analyte measurement. Similarly, wavelength shifts of only one nanometer can induce errors in the measurement of certain blood analytes which are large enough to make these blood analyte measurements clinically useless.

One common solution to the back reflection problem is to use an optical isolator to block back reflections into the laser. An optical isolator typically consists of a Faraday rotator positioned between a pair of polarizers. While optical isolators can be very effective in blocking or preventing back reflections, they have the disadvantages of being rather large and expensive optical elements. Their use may also require additional collimating and focusing optics, which further diminishes the optical throughput of the system.

U.S. Pat. No. 4,880,304 discusses an “improved optical sensor” for a pulse oximeter. The specification discloses the possibility of “coating the respective LEDs with a polymer sealant” and mentions that this “coating provides improved optical index matching and also provides an electrical and biological seal between the sensor and the tissue.” The patent also mentions the possibility of replacing the LEDs with laser light sources, but it does not specifically mention the possibility of coating the laser facets with the polymer sealant or that such a coating could prevent the laser or lasers from functioning due to the coating altering the reflectivity of the laser cavity facets. Furthermore this patent describes a sensor configuration in which the emitters, regardless of the specific type, are positioned in the sensor and in close proximity to the tissue-under-test, thus eliminating the need for a series of optical elements to form a continuous light guide for conducting light from the emitters to the tissue-under-test. This patent also did not consider consequences of back reflection of the laser light or how to minimize the back reflection that could occur at the interface between any two elements in the light guide.

US patent application publication No. 2004/0153008 states the possibility of using “a coupling gel” between the “tissue interface and the instrument section” presumably to enhance transmission of an ultrasonic signal. While this patent application mentions oximetry sensors it does not mention the use of coupling gel in combination with the oximetry sensor, nor does it discuss light guides, laser-based photoplethysmography, or the use of coupling gel in combination with the elements of a light guide.

US patent application publication No. 2005/0187439 discusses the use of coupling fluids to reduce the back reflection between “a sample site and an interfacing sample probe surface”, to minimize “applied pressure at the sample site”, and to aid in “stabilizing hydration of surface tissue.” It does not, however, discuss the use of coupling fluids in photoplethysmography, nor does this patent discuss the use of the coupling fluids used between any two elements in a series of optical elements used to create a light guide for transmitting the light from the emitters to the tissue-under-test. It also does not solve the problem of the back reflection of laser light in laser-based photoplethysmography.

### BRIEF SUMMARY OF THE INVENTION

In accordance with one embodiment a light delivery apparatus for a photoplethysmographic device comprises a light guide comprising a series of two or more optical elements conducting laser light wherein the two or more elements are coupled together by a non-reflective coupling. Accordingly, several advantages of one or more aspects are as follows: that a minimum of light exiting one optical element in the light guide and entering the next consecutive element is reflected from the interface between the two elements, thus minimizing the likelihood of adversely affecting the wavelength or intensity stability of the light emitted by the laser; and, that a minimum percentage of the light crossing the interface and being coupled into the second consecutive optical element is lost to back reflection, thus maximizing the light available for sensing of the desired blood analytes, hemodynamic parameters, or tissue properties.

### DRAWINGS

FIG. 1. Light delivery system for a photoplethysmographic device—Physical Contact

FIG. 2. Light delivery system for a photoplethysmographic device—Optical Coupling Medium

### DETAILED DESCRIPTION OF THE INVENTION

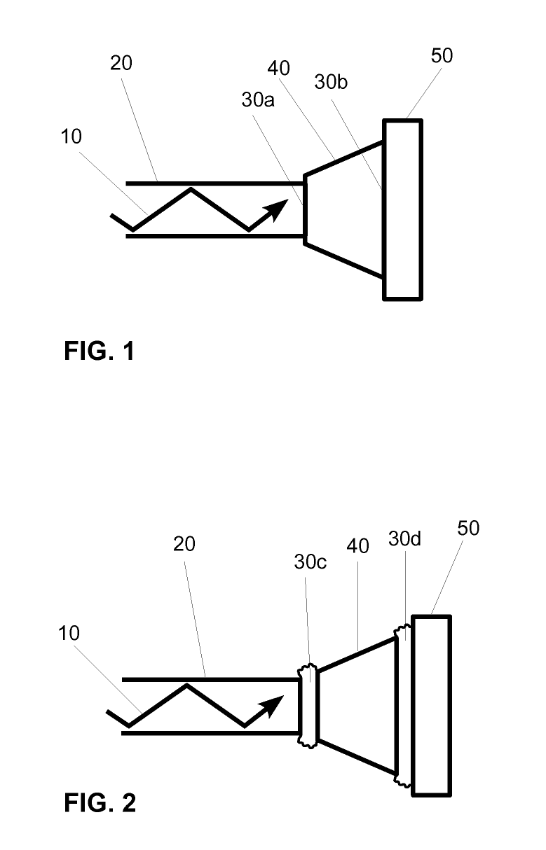

One embodiment of a light delivery apparatus for a photoplethysmographic device is shown in FIG. 1. Laser light 10 is propagating through optical element 20 toward optical element 40. The light from optical element 20 propagates across the physical contact connection 30a and then propagates through optical element 40 toward optical element 50. In passing from optical element 40 to optical element 50 the laser light again passes through a physical contact connection 30b.

In conventional photoplethysmographic devices the light sources, also called emitters, generate the light that is used for sensing the blood analytes or the physiological parameters to be measured. The analytes or physiological parameters to be measured may include arterial blood oxygen saturation or level (also referred to as O₂Hb, [O₂Hb], SaO₂, or SₚO₂), carboxyhemoglobin level (also referred to as COHb, [COHb], or SₚCO), methemoglobin level (also referred to as metHb, [metHb], or Sₚmet), pulse rate (also called heart rate, HR, or PR), and perfusion index (also called PI), along with many others. In pulse oximetry, a common photoplethysmographic device, the emitters used for these measurements typically consist of light emitting diodes (LEDs), although several other light sources have been used including, in the earliest pulse oximeters, tungsten lamps.

In the typical conventional pulse oximeter the LEDs are housed in the sensor. Light emitted by the LEDs may pass through a diffuser, or other intervening optics, and then the light passes through an output window, or aperture, and is incident directly on the tissue-under-test. A small portion of the light then passes through the tissue-under-test and is received by a photodetector that is typically positioned a short distance from where the light originally entered the tissue-under-test. The photodetector signal is measured by the photoplethysmographic instrument and processed into the desired measurements. The conventional pulse oximeter is only capable of measuring oxygen saturation (SₚO₂) and perhaps heart rate (HR) and perfusion index (PI). SₚO₂ is an estimate of the fractional oxygen saturation of the arterial blood, but only when the COHb and the metHb are at normal physiological levels. In a case where the COHb or the metHb is elevated, the SₚO₂, as read by a conventional “two wavelength” (or, more accurately, two distinct spectral bands, typically each one generated by an LED light source housed in the sensor) pulse oximeter, reads an erroneously-elevated oxygen saturation. This is a potentially dangerous scenario because the oximeter may be displaying normal oxygen saturation when in fact the arterial oxygen saturation is at a dangerously low level.

With the increasing desire to measure more blood analytes and physiological parameters, and with ever-increasing accuracy, the emitter types now being used include lasers. Lasers are a type of emitter that can generate light with a much narrower spectral bandwidth than conventional LEDs. The use of lasers in photoplethysmographic devices provides the opportunity for increased measurement accuracy and precision as well as the opportunity to measure additional parameters and/or blood analytes that were not attainable with more broadband light sources.

One difficulty in using a laser light source is that many lasers types are sensitive to back reflection of the laser light into the laser cavity. As discussed earlier, back reflection, or reflection of some portion of the light emitted by the laser back into the laser cavity, can generate or increase fluctuations in intensity and alterations in spectral content of the output light. This diminishes the value of using a laser light source for photoplethysmographic measurement.

To prevent the problems associated with back reflection of laser light into the laser cavity, and to maximize the amount of light propagating through the series of optical elements arranged to make up a contiguous light guide, the embodiment shown in FIG. 1 includes physical contact connections, 30a and 30b, between the optical elements 20, 40, and 50. Obviously the optical elements would typically be physically arranged in a contiguous manner such that the light emitted from one element can be maximally collected by the following optical element. This is typically done by substantially aligning the central optical axis of the series of consecutive optical elements in the light guide and by ensuring that the numerical aperture (N.A.) of each succeeding element is equal to, or larger than the N.A. of the preceding optical element.

Shown in FIG. 1 in schematic form, the series optical elements 20, 40, and 50 making up the continuous light guide may be comprised of any of a number of different light conducting, light diffusing, light spreading, light reflecting, or light dispersing components. This would include, for example, glass or plastic fiber optics, liquid light guides, prisms, internally reflective prisms, mirrored prisms, light shaping diffusers, plastic light pipes, lenses, or other such elements.

Again referring to FIG. 1, and by way of one example, in a photoplethysmographic device the laser light 10 generated by a laser-based emitter (not shown) would be conducted by optical element 20 which might be an optical fiber (or it could be a series of optical fibers each connected to the next by some type of non-reflective, or anti-reflective, connection). Then optical element 40, connected to the previous element 20 by a non-reflective connection 30a, might be a prism intended to expand out the light delivered by the optical fiber. The prism then might be connected by a non-reflective connection 30b to a diffusing element 50 which would serve to better homogenize the light before the light is launched into the tissue-under-test.

A diffuser might be particularly important if, for example, element 20 was a bundle of two or more optical fibers each carrying light from a different emitter. In this case the light entering element 40 would not be well mixed and a diffusing element, included as one of the elements in the series of optical elements that make up the light guide as shown in FIG. 1 or FIG. 2, would help to homogenize the light before it entered the tissue-under-test. For optimum mixing of the light incident on the tissue-under-test, the diffusing element might not be the last element in the light guide so that more mixing of the light could occur before the light is launched into the tissue-under-test. The specific order and number of the optical elements in this system can vary greatly without changing the need to minimize the back reflection of laser light and therefore the need to use a non-reflective, or anti-reflective, connection in a series of optically conductive elements for delivery of laser light from a laser source to a tissue-under-test.

Some laser light could be reflected off the final optical surface (before being launched into the tissue-under-test) or even off the tissue-under-test itself. Thus it is advantageous to minimize this effect as well. An optical system designed so that the last optical elements in the series of optical elements have a larger diameter than the earlier elements in the chain, such as is shown in the embodiment of FIG. 1 or FIG. 2, would reduce the amount of, light that could be launched back into optical element 20 and finally back into the laser cavity to such a small fraction of a percent that it would be extremely unlikely to alter the optical output properties of the laser. The same can not be said of laser light back reflected off one of the earlier connections in the light guide if a proper non-reflective connection is not used.

A physical contact connection 30a or 30b is a connection which puts the two consecutive optical elements to be connected into intimate physical contact with each other. This eliminates the back reflection (also called Fresnel reflection) that occurs when light launched from one optical element to the next travels through a medium, such as air, with a different index of refraction. A typical physical contact connector will actually apply a force across the contact surfaces (also called mating surfaces) of the two optical elements to maintain the physical contact connection. While the intention of such connector is to maintain the physical contact across the entire mating surface, it is well recognized that some air gap may exist over the mating surface due to imperfections in the desired polish of these surfaces. If these gaps are small enough, relative to the wavelength of the light being launched from one element into the next, the Fresnel reflection will still be eliminated.

FIG. 2 shows another embodiment of a light delivery apparatus for a photoplethysmographic device. Laser light 10 is propagating through a series of optical elements. The light from optical element 20 is coupled into optical element 40 though an optical coupling medium 30c. The light then propagates through optical element 40 toward optical element 50. In passing from optical element 40 to optical element 50 the laser light again passes through an optical coupling medium 30d.

An optical coupling medium is typically a transparent medium or material used to fill in a gap between two optical elements. It also provides a close match in index of refraction to that of the optical elements on which it is being used. An optical coupling medium might be an oil or grease specifically designed (or selected) to be substantially transparent or clear to the wavelengths of light being used and to match the index of refraction of the optical elements closely enough to substantially eliminate Fresnel reflection. It might also be a gel with similar optical properties to that of an optical coupling oil, chosen for other properties such as remaining viscous at elevated service temperatures. Index coupling oils, greases, and gels can be made from many different materials, examples of which are silicones, polymers, and chlorofluorocarbons (CFCs). Furthermore, an optical coupling medium might be an index-matching compliant pad, which could also be termed a gasket or interface, installed between two optical components, and which could include an index-matching material that becomes semi-rigid after assembly, such as could be created by cross-linking a polymer using either ultraviolet (UV) light or by the addition of a catalyst. Finally, an optical coupling medium may be an optically clear adhesive, such as an epoxy, that again is substantially transparent to the wavelengths of light being used and which provides a reasonably close match to the index of refraction of the optical elements being coupled together so that laser light can pass from one to the next without, or at least with a minimum of, back reflection.

Photoplethysmographic devices typically employ several emitters to allow accurate measurement of numerous blood analytes and/or physiological parameters. The same light delivery portion of a photoplethysmographic device described above may be utilized multiple times within the device. In addition to preventing or at least minimizing back reflection of light into the laser, the use of physical contact connectors or optical coupling medium as described herein has the additional advantage of reducing overall light losses in the optical system because light that is reflected off any optical element in the series of optical elements used to deliver the light to the tissue-under-test is light that is not available for sensing.

The previous discussion of the embodiments has been presented for the purposes of illustration and description. The description is not intended to limit the invention to the form disclosed herein. Variations and modifications commensurate with the above are considered to be within the scope of the present invention. The embodiments described herein are further intended to explain the best modes presently known of practicing the invention and to enable others skilled in the art to utilize the invention as such, or in other embodiments, and with the particular modifications required by their particular application or uses of the invention. It is intended that the appended claims be construed to include alternative embodiments to the extent permitted by the prior art.

1) A light delivery apparatus for a photoplethysmographic device comprising:
a. a series of two or more optical elements;
b. the series of two or more optical elements arranged to conduct light from a laser;
c. at least two consecutive elements of the series of two or more optical elements coupled together by a non-reflective coupling;
whereby the non-reflective coupling minimizes back reflection and light loss as light propagates across the non-reflective coupling.

2) The apparatus of claim 1 wherein the non-reflective coupling is provided by a physical contact connection.

3) The apparatus of claim 1 wherein the non-reflective coupling is provided by an optical coupling medium.

4) The apparatus of claim 3 wherein the optical coupling medium is an optically clear adhesive.

5) The apparatus of claim 3 wherein the optical coupling medium is an optical coupling gel.

6) The apparatus of claim 3 wherein the optical coupling medium is an optical coupling oil.

7) The apparatus of claim 3 wherein the optical coupling medium is an optical coupling pad.

8) In a photoplethysmographic measurement system, a method for delivering light comprising the steps of:
a. providing a series of optical elements;
b. arranging the series of optical elements to conduct light from a laser;
c. coupling at least two consecutive elements of the series of optical elements with a non-reflective coupling.

9) The method of claim 8 wherein the non-reflective coupling comprises a physical contact connection.

10) The method of claim 8 wherein the non-reflective coupling comprises an optical coupling medium.

11) The method of claim 10 wherein the optical coupling medium comprises an optically clear adhesive.

12) The method of claim 10 wherein the optical coupling medium comprises an optical coupling gel.

13) The method of claim 10 wherein the optical coupling medium comprises an optical coupling oil.

14) The method of claim 10 wherein the optical coupling medium comprises an optical coupling pad.
